(19) United States
(12) Patent Application Publication
(10) Pub. No.: US 2025/0379218 A1
(43) Pub. Date: Dec. 11, 2025

(54) COMPOSITE ACTIVE MATERIAL

(71) Applicants: TOYOTA JIDOSHA KABUSHIKI KAISHA, Toyota-shi (JP); Panasonic Holdings Corporation, Kodoma-shi (JP)

(72) Inventors: Masahiro IWASAKI, Toyota-shi (JP); Hiroki YABE, Hirakata-shi (JP); Yusuke ITO, Kadoma-shi (JP); Izuru SASAKI, Kyoto-shi, Kyoto-fu (JP)

(73) Assignees: TOYOTA JIDOSHA KABUSHIKI KAISHA, Toyota-shi (JP); Panasonic Holdings Corporation, Kodoma-shi (JP)

(21) Appl. No.: 19/221,748

(22) Filed: May 29, 2025

(30) Foreign Application Priority Data
Jun. 5, 2024 (JP) 2024-091310

(51) Int. Cl. H01M 4/36; H01M 10/0562

(52) U.S. Cl. CPC H01M 4/366; H01M 10/0562; H01M 2300/008

(57) ABSTRACT

Provided is a composite active material that is capable of more suppressing deterioration of an active material caused by the moisture of the composite active material than a conventional composite active material by increasing a permissible water content of a layer of the composite active material. The composite active material that is used for solid-state batteries includes: an active material; a first coat layer that contains a fluoride-containing first solid electrolyte, the first coat layer coating at least part of a surface of the active material; and a second coat layer that contains a sulfide-containing second solid electrolyte, and a solvent, the second coat layer coating at least part of the first coat layer, wherein a water content of the composite active material at 200° C. measures at most 823 ppm on a Karl Fischer titrator.

### BACKGROUND

### 1. Field

The present disclosure relates to composite active materials.

### 2. Description of the Related Art

Patent Literature 1 discloses lowering resistance by configuring a coated active material that includes: a positive electrode active material having a water content higher than 0 ppm and lower than 250 ppm per unit mass; and a coat layer coating at least part of the surface of the positive electrode active material.
Patent Literature 1: WO 2023/037775 A1

### SUMMARY

When the positive electrode active material is coated with a material containing a lithium-containing fluoride, the moisture of the positive electrode active material changes properties of part of the coat layer, thereby generating a resistive layer on the interface. Therefore, the more the moisture of the positive electrode active material is, the higher the output resistance is, which is problematic. Further, generally, moisture adsorption on a positive electrode active material generates a resistive layer on the interface as well, which causes output resistance to be higher, which is problematic.

In view of the foregoing problems, an object of the present disclosure is to provide a composite active material that is capable of more suppressing deterioration of an active material caused by the moisture of the composite active material than a conventional composite active material by increasing a permissible water content of a layer of the composite active material.

The present application discloses a composite active material that is used for solid-state batteries, the composite active material comprising: an active material; a first coat layer that contains a fluoride-containing first solid electrolyte, the first coat layer coating at least part of a surface of the active material; and a second coat layer that contains a sulfide-containing second solid electrolyte, and a solvent, the second coat layer coating at least part of the first coat layer, wherein a water content of the composite active material at 200° C. measures at most 823 ppm on a Karl Fischer titrator.

Here, the “water content of the composite active material at 200° C. measures . . . on a Karl Fischer titrator” is a value calculated as follows using Karl Fischer equipment (Karl Fischer titrator).

In a dry nitrogen gas atmosphere, an introduction part for the composite active material, which is a measurement sample, is heated to 300° C. in advance to stabilize the equipment by preheating. After the equipment is stabilized, the temperature of the introduction part is set at 200° C. After the temperature of the introduction part is at 200° C., the background moisture release rate (μg/sec.) is measured.

The temperature of the introduction part is set at 25° C. After the temperature of the introduction part is at 25° C., the composite active material, which is a measurement sample, is introduced into the introduction part. The composite active material, which is a measurement sample, is heated from 25° C. to 200° C. at the temperature rise rate of 10° C. per minute to vaporize the moisture contained in the composite active material, which is a measurement sample. The vaporized moisture is quantitated by coulometric titration until the quantitated value is at most the background moisture release rate to obtain the water content. The water content quantitated at this time is defined as the “water content at 200° C.”.

The water content of the composite active material at 200° C. may measure at least 10 ppm on a Karl Fischer titrator.

In the water content of the composite active material, a water content of the second coat layer may be higher than a water content of the first coat layer.

The composite active material according to the present disclosure includes two different types of coat layers on the surface of the active material, thereby being capable of suppressing deterioration of the active material caused by moisture. This is because a high water content of the second coat layer can lead to reduced moisture adsorption on the active material, which causes the composite active material as a whole to permit more moisture to be contained therein than a conventional composite active material.

### BRIEF DESCRIPTION OF THE DRAWINGS

FIG. 1 schematically shows a composite active material; and

FIG. 2 schematically shows composition of layers of a solid-state battery.

### DESCRIPTION OF THE PREFERRED EMBODIMENTS

Hereinafter embodiments of the present disclosure will be described in detail. The present disclosure is enabled without any limitation to the following embodiments but with various modifications within the scope of the gist of the present disclosure.

With respect to the present disclosure, a “solid-state battery” means a battery using at least a solid electrolyte as an electrolyte. Therefore, the solid-state battery may use a solid electrolyte and a liquid electrolyte in combination as an electrolyte. In the present disclosure, the solid-state battery may be an all-solid-state battery, that is, a battery using a solid electrolyte only as an electrolyte.

### 1. Composite Active Material

A composite active material as used herein is a substance that is to be a raw material of electrodes, and is in the form of sphere, ellipsoid, flake, fiber, or the like. The composite active material can have any of various properties such as granular, powdery, and clayey properties.

The composite active material may have a D50 of, for example, 1 μm to 30 μm, 3 μm to 20 μm, or 5 μm to 15 μm. Here, the “D50” indicates the particle diameter in the volume-based particle diameter distribution at which the cumulative volume index in ascending order reaches 50%. A laser diffraction particle size distribution analyzer can measure the D50.

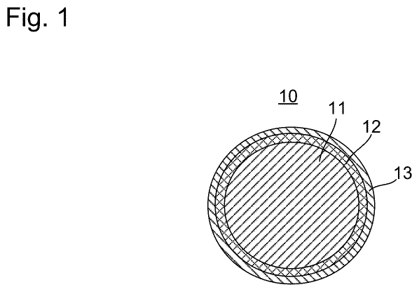

FIG. 1 shows the structure of a composite active material 10 according to one embodiment (in the form of sphere) in a schematically cross-sectional manner.

The composite active material 10 includes an active material 11, a first coat layer 12 and a second coat layer 13, which will be described below in more detail.

### 1.1. Active Material

The active material 11 is a substance that functions as the core of the composite active material 10, and is in the form of particle. The active material may be, for example, a secondary particle. The secondary particle here is agglomerate of primary particles. The secondary particle may have a D50 of, for example, 1 μm to 30 μm, 3 μm to 20 μm, or 5 μm to 15 μm. The primary particles may have a mean Feret diameter of, for example, 0.01 μm to 3 μm. The “mean Feret diameter” is the arithmetic mean value of the maximum Feret diameters of at least 20 particles measured in a two-dimensional image of the particles.

The active material 11 may have any shape. The active material may be in the form of, for example, sphere, ellipsoid, flake or fiber. The active material may be a solid particle, and may be a hollow particle.

Here, the “solid particle” indicates a particle in which a cavity at the central part has an area smaller than 30% of the cross-sectional area of the entire particle in a cross-sectional image of the particle. In contrast, the “hollow particle” indicates a particle in which a cavity at the central part has an area at least 30% of the cross-sectional area of the entire particle in a cross-sectional image (such as a cross-sectional SEM image) of the particle.

The active material 11 may be, for example, a positive electrode active material. The positive electrode active material can cause a positive electrode reaction. The positive electrode active material may contain any component. The positive electrode active material may contain, for example, at least one selected from the group consisting of LiCoO₂, LiNiO₂, LiMnO₂, LiMn₂O₄, Li(NiCoMn)O₂, Li(NiCoAl)O₂, Li(NiCoMnAl)O₂ and LiFePO₄. For example, “(NiCoMn)” in “Li(NiCoMn)O₂” indicates that the sum of the values of the composition ratio in the parentheses is 1. Each of the components may be in any amount as long as the sum is 1. Li(NiCoMn)O₂ may encompass, for example, at least one selected from the group consisting of LiNi_{1/3}Co_{1/3}Mn_{1/3}O₂, LiNi_{0.4}Co_{0.3}Mn_{0.3}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂ and LiNi_{0.9}Co_{0.05}Mn_{0.05}O₂. Li(NiCoAl)O₂ may encompass, for example, LiNi_{0.8}Co_{0.15}Al_{0.05}O₂.

The positive electrode active material may be represented by, for example, the following formula:

$$\begin{matrix}{Li}_{1 - y} {Ni}_{x} {M}_{1 - x} {O}_{2} \\ where 0.5 \leq x \leq 1 , and \\ - 0.5 \leq y \leq 0.5 .\end{matrix}$$

In the above formula, M may include, for example, at least one selected from the group consisting of Co, Mn and Al. For example, x may be at least 0.6, may be at least 0.7, may be at least 0.8, and may be at least 0.9.

The positive electrode active material may contain, for example, an additive. The additive may be, for example, a substitutional solid solution atom or an interstitial solid solution atom. The additive may be an adhered material that adheres to the surface of the positive electrode active material (primary particles). The adhered material may be, for example, a simple substance, an oxide, a carbide, a nitride and a halide. The additive amount may be, for example, 0.01 to 0.1, 0.02 to 0.08, or 0.04 to 0.06. The additive amount indicates the proportion of the amount of substance of the additive to the amount of substance of the positive electrode active material. The additive may contain, for example, at least one selected from the group consisting of B, C, N, halogen, Sc, Ti, V, Cu, Zn, Ga, Ge, Se, Sr, Y, Zr, Nb, Mo, In, Sn, W, and a lanthanoid.

On the contrary, the active material may be a negative electrode active material. The negative electrode active material can cause a negative electrode reaction. The negative electrode active material may contain any component. The negative electrode active material may contain, for example, at least one selected from the group consisting of natural graphite, artificial graphite, soft carbon, hard carbon, Si, SiOₓ (0<x<2), a Si-based alloy, Sn, SnOₓ (0<x<2), Li, a Li-based alloy, and Li₄Ti₅O₁₂. SiOₓ (0<x<2) may be doped with, for example, Mg. A composite material may be formed by supporting an alloy-based active material (such as Si) on a carbon-based active material (such as graphite).

### 1.2. First Coat Layer

The first coat layer 12 is the layer coating at least part of the outer periphery of the active material 11, and is a layer made from a first solid electrolyte comprising a fluoride (fluoride solid electrolyte). The fluoride solid electrolyte is interposed between the active material 11, and a sulfide solid electrolyte contained in the second coat layer 13 which will be described later. The fluoride solid electrolyte can promote the formation of the interface between the fluoride solid electrolyte and the sulfide solid electrolyte even under the coexistence of solvent. The fluoride solid electrolyte coats at least part of the surface of the active material 11.

The first coat layer 12 may have a thickness of, for example, 1 nm to 100 nm, or 1 nm to 50 nm. The amount of incorporating the fluoride solid electrolyte on the basis of 100 parts by mass of the active material 11 may be, for example, 1 part by mass to 10 parts by mass, or 2 parts by mass to 3 parts by mass.

Here, the “coating thickness” can be measured by the following procedures. A sample is prepared by embedding, into a resin material, the active material 11 coated with the first coat layer 12. The sample is cross-sectioned using an ion-milling system. For example, “Arblade (registered trademark) 5000 (product name)”, which is manufactured by Hitachi High-Technologies Corporation, (or any equivalent product thereof) may be used. The cross section of the sample is observed using a scanning electron microscope (SEM). For example, “SU8030 (product name)”, which is manufactured by Hitachi High-Technologies Corporation, (or any equivalent product thereof) may be used. For each of ten composite particles, the thickness of the fluoride solid electrolyte (SE) is measured in twenty fields of view. The arithmetic mean of the thicknesses in the two hundred fields in total is regarded as the coating thickness. The thickness of the coating made from the fluoride solid electrolyte may be also referred to as the “buffer layer thickness”.

The coating thickness may be measured in an elemental mapping image by energy dispersive X-ray spectrometry (SEM-EDX). In the elemental mapping image, elements representative of the respective parts are selected.

The first coat layer 12 may coat the entire surface of the active material 11, and may coat part of the surface thereof. The first coat layer 12 may be insularly distributed across the surface of the active material 11. The coverage ratio may be, for example, 50% to 100%, 60% to 100%, 70% to 100%, 80% to 100%, or 90% to 100%. The higher the coverage ratio is, for example, the lower the initial resistance is expected to be.

The “coverage ratio” is measured by the following procedures. In the same manner as for the sample for measuring the coating thickness, the active material 11 coated with the first coat layer 12 is cross-sectioned to prepare a sample. In the cross-sectional SEM image, the length of the border line of the active material (L₀) is measured. The length of the section in the border line of the active material 11 that is coated with the first coat layer 12 (L₁) is measured. The percentage of the value obtained by dividing L₁ by L₀ is the coverage ratio. The coverage ratio is measured for each of twenty composite particles.

The arithmetic mean of the twenty coverage ratios is regarded as the “coverage ratio”.

For example, L₀ and L₁ may be calculated by subjecting the elemental mapping image by SEM-EDX to image processing.

The fluoride solid electrolyte (first solid electrolyte) may have any composition as long as containing F. The fluoride solid electrolyte may contain, for example, Li and F.

The fluoride solid electrolyte may be represented by, for example, the following formula:

$${Li}_{6 - nx} {M}_{x} {F}_{6} .$$

In this formula, x satisfies 0<x<2. M is at least one selected from the group consisting of a metalloid atom, and a metal atom excluding Li. n indicates the oxidation number of M.

In this formula, M may include a single atom, and may include a plurality of kinds of atoms. When M includes a plurality of kinds of atoms, n indicates the weighted average of the oxidation numbers of the respective kinds of the atoms. For example, when M includes Ti (oxidation number is +4) and Al (oxidation number is +3), the molar ratio of Ti and Al is “Ti/Al=3/7”, and x=1, the numerical expression “n=0.3×4+0.7×3” gives n=3.3.

x may satisfy, for example, 0.1≤x≤1.9, 0.2≤x≤1.8, 0.3≤x≤1.7, 0.4≤x≤1.6, 0.5≤x≤1.5, 0.6≤x≤1.4, 0.7≤x≤1.3, 0.8≤x≤1.2, or 0.9≤x≤1.1.

M may include, for example, an atom having an oxidation number of +4. M may include, for example, an atom having an oxidation number of +3. M may include, for example, an atom having an oxidation number of +4, and an atom having an oxidation number of +3.

M may include, for example, at least one selected from the group consisting of Ca, Mg, Al, Y, Ti and Zr. M may include, for example, at least one selected from the group consisting of Al, Y and Ti. M may include, for example, at least one selected from the group consisting of Al and Ti.

The fluoride solid electrolyte may be represented by, for example, the following formula:

$${Li}_{3 - x} {Ti}_{x} {Al}_{1 - x} {F}_{6} .$$

In this formula, x may satisfy, for example, 0≤x≤1, 0.1≤x≤0.9, 0.25≤x≤0.8, 0.3≤x≤0.7, or 0.4≤x≤0.6.

### 1.3. Second Coat Layer

The second coat layer 13 is the layer further coating the active material 11 coated with the first coat layer 12, and is a layer made from a second solid electrolyte comprising a sulfide (sulfide solid electrolyte), and a solvent.

### 1.3.1. Sulfide Solid Electrolyte (Second Solid Electrolyte)

The sulfide solid electrolyte, together with the solvent, adheres to the outer surface of the active material 11 coated with the first coat layer 12. The sulfide solid electrolyte is in the form of particle, and may have a D50 of, for example, 0.01 μm to 1 μm, or 0.1 μm to 0.9 μm. The amount of incorporating the sulfide solid electrolyte on the basis of 100 parts by mass of the active material 11 may be, for example, 0.1 part by mass to 20 parts by mass, or 0.5 part by mass to 15 parts by mass.

The sulfide solid electrolyte can exhibit high ion conductivity. The sulfide solid electrolyte may have any composition as long as containing S (sulfur). The sulfide solid electrolyte may contain, for example, Li, P and S. The sulfide solid electrolyte may further contain, for example, O, Ge and Si. The sulfide solid electrolyte may further contain, for example, a halogen. The sulfide solid electrolyte may further contain, for example, I and Br. For example, the sulfide solid electrolyte may be of glass ceramic type, and may be of argyrodite type. The sulfide SE may contain, for example, at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—GeS₂—P₂S₅, Li₂S—P₂S₅, Li₄P₂S₆, Li₇P₃S₁₁, and Li₃PS₄.

For example, “LiI—LiBr—Li₃PS₄” indicates a sulfide solid electrolyte generated by mixing LiI, LiBr and Li₃PS₄ at a certain molar ratio. For example, the sulfide solid electrolyte may be generated by a mechanochemical process. “Li₂S—P₂S₅” encompasses Li₃PS₄. Li₃PS₄ here can be generated by, for example, mixing Li₂S and P₂S₅ at a molar ratio of “Li₂S/P₂S₅=75/25”.

### 1.3.2. Solvent

The solvent is a liquid, and promotes adhesion of the active material 11 coated with the first coat layer 12, and the sulfide solid electrolyte to each other in stiff kneading. The solvent can function as a dispersion medium in a slurry. The solvent may contain any component, and for example, may contain at least one selected from the group consisting of an aromatic hydrocarbon, ester, alcohol, ketone, and lactam. The solvent may contain, for example, at least one selected from the group consisting of tetralin (1,2,3,4-tetrahydronaphthalene, THN), butyl butyrate, heptane, and N-methyl-2-pyrrolidone (NMP).

It is expected to be more difficult that butyl butyrate degrades the sulfide solid electrolyte than, for example, NMP does. It is expected to be more difficult that THN degrades the sulfide solid electrolyte than each of butyl butyrate, NMP, etc. does. When the solvent contains THN, the initial resistance is expected to be lower.

### 1.4. Contained Moisture

The water content of the composite active material at 200° C. is at most 823 ppm, and the lower limit thereof is preferably 10 ppm.

Here, the “water content at 200° C.” is a value calculated as follows using Karl Fischer equipment (Karl Fischer titrator).

In a dry nitrogen gas atmosphere, an introduction part for the composite active material, which is a measurement sample, is heated to 300° C. in advance to stabilize the equipment by preheating. After the equipment is stabilized, the temperature of the introduction part is set at 200° C. After the temperature of the introduction part is at 200° C., the background moisture release rate (μg/sec.) is measured.

The temperature of the introduction part is set at 25° C. After the temperature of the introduction part is at 25° C., the measurement sample is introduced into the introduction part. The measurement sample is heated from 25° C. to 200° C. at the temperature rise rate of 10° C. per minute to vaporize the moisture contained in the measurement sample. The vaporized moisture is quantitated by coulometric titration until the quantitated value is at most the background moisture release rate to obtain the water content. The water content quantitated at this time is defined as the “water content at 200° C.”.

In the present embodiment, in the composite active material, preferably, more moisture is contained in the second coat layer 13 than in the first coat layer 12.

In the composite active material according to the present disclosure, the first coat layer 12 is formed for efficiently receiving and giving electrons and lithium ions on the interface of the active material. In the present disclosure, because the second coat layer 13 is present on the outermost layer of the composite active material, which easily comes into contact with moisture, moisture tends to remain in the second coat layer 13. Because of this, preferably, more moisture is contained in the second coat layer 13 than in the first coat layer 12.

For more details, see the following.

The composite active material according to the present disclosure, and a composite active material including no second coat layer 12, which is included in the present disclosure, (conventional composite active material) are exposed to an environment having a dew point of −5° C. for 9 minutes, and thereafter compared. As a result, the moisture present in the first coat layer of the composite active material according to the present disclosure is less than that of the conventional composite active material. This is proved by subjecting cross-sectional SEM images of the composite active materials (images obtained using a scanning electron microscope) to EDS line analysis (line analysis by energy dispersive X-ray spectroscopy) in such a manner that the line crosses the active materials and the first coat layers (and the second coat layer if necessary). More specifically, for each of the first coat layers, the element ratio of fluorine and oxygen at the point where fluorine derived from the fluoride solid electrolyte is detected most is obtained, and the element ratio of the composite active material according to the present disclosure and that of the conventional composite active material are compared with each other. As a result, the moisture in the first coat layer of the composite active material according to the present disclosure is less than that of the conventional composite active material. Here, oxygen means oxygen atoms derived from water molecules. The output resistance of a battery using the composite active material according to the present disclosure as a positive electrode is also lower than that of a battery using the conventional composite active material as a positive electrode.

In the composite active material according to the present disclosure, the moisture contained in the first coat layer 12 and the active material 11 can move to the second coat layer 13. The moisture in the second coat layer 13 may move to a solvent that the second coat layer 13 comes into contact with in a paste when an electrode is made, to be removed; and may be removed in drying after electrode film formation.

### 1.5. Effect etc.

The composite active material according to the present disclosure can improve the moisture tolerance (property that prevents deterioration of the active material due to moisture that is followed by an increased reaction resistance) of the composite active material 10. The composite active material according to the present disclosure has moisture tolerance even if retaining a somewhat high water content. This is considered to be because deterioration in the first coat layer 12 and the active material 11 can be suppressed since moisture can be contained preferentially in the second solid electrolyte and the solvent of the second coat layer 13. The moisture originally contained in the active material and the first coat layer can also move to the second coat layer.

As will be described in the examples later, the following effect was also observed: the higher than the reference value the water content is, the more the resistance increase rate rather decreases.

### 2. Producing Composite Active Material

In one example of the method of producing the composite active material, the following steps are included. Hereinafter each of the steps will be described.

### 2.1. Step of Forming First Coat Layer

Formation of the first coat layer 12 on the active material 11 is carried out by any method. An example of such a method is a dry mechanochemical method. More specifically, such formation can be carried out by mixing the active material 11 and the fluoride solid electrolyte by the use of a particle composing machine. An example of such a particle composing machine is “Nobilta NOB-MINI”, which is manufactured by Hosokawa Micron Corporation. Any mixer, granulator, or the like may be used as long as the particle can be composed.

### 2.2. Pre-Kneading Step

Prior to carrying out a pre-kneading step, a material that is to be the second coat layer 13 is prepared. Specifically, a fluid dispersion may be prepared by, for example, dispersing a sulfide solid electrolyte that is a powder throughout a solvent that is a liquid. Equipment for the dispersion is not particularly limited, but an example thereof is an ultrasonic homogenizer.

In the pre-kneading step, stiff kneading, and addition of the solvent are each alternately carried out twice or more. Pre-kneading is carried out by stirring, in a kneader (such as a planetary centrifugal mixer), the active material 11 (powder) coated with the first coat layer 12, which is obtained in the step of forming the first coat layer, and the fluid dispersion for the second coat layer 13, which is prepared as described above. As a result of this, the mixture starts being viscous. For example, the mixture may be stirred at a rotational speed of 50 rpm to 100 rpm for 1 minute to 1 hour. The mixing conditions (the rotational speed, the mixing time, etc.) may vary depending on, for example, powder properties, the specifications of the kneader, etc. Repeating the stiff kneading and the solvent addition in turn can result in more compact coating with the second coat layer 13.

The form before stiff kneading is that the first coat layer 12 is coated with the solvent of the second coat layer 13, and the sulfide solid electrolyte of the second coat layer 13 disperses throughout the solvent. In this state, absorption of the solvent into the active material 11 coated with the first coat layer 12 tends to be difficult to progress. In contrast, carrying out stiff kneading leads to changes in surface properties of the active material 11 coated with the first coat layer 12 to promote absorption of the solvent into the solid component, and part of the solvent evaporates. This causes a shortage of the solvent required for stiff kneading. For this shortage of the solvent, stiff kneading is carried out with an additional solvent whereby the absorption of the solvent further progresses.

Repeating such stiff kneading and solvent addition gradually leads to formation of a compact coat layer made from the sulfide solid electrolyte to form the second coat layer 13.

### 2.3. Final Kneading Step

In the final kneading step, kneading is carried out following the pre-kneading step. In the final kneading step, stiff kneading is also carried out following the pre-kneading step, but no solvent is added. In the final kneading step, kneading at a faster rotational speed for a longer time than in the pre-kneading step is carried out. Specifically, for example, the mixture may be stirred at a rotational speed of 100 rpm to 200 rpm for 2 hours to 6 hours. The final kneading is preferably carried out while scraping off the material adhering to the edge of the kneader as necessary or periodically, and checking the condition.

As a result of the above, the active material 11 coated with the first coat layer 12 and the second coat layer 13 is obtained.

### 2.4. Step of Adjusting Water Content

The water content of the active material 11 coated with the first coat layer 12 and the second coat layer 13 which is obtained in the final kneading step is adjusted, so that the water content thereof at 200° C. (the definition of this water content is as described above) is at most 823 ppm as described above. The adjustment of the water content can be carried out, for example, by: putting the active material after the final kneading in a glove box where the dew point is controlled to be at −5° C. to expose the active material to the environment in the glove box, so that the active material adsorbs moisture. The water content is adjusted depending on an appropriate exposure time that is calculated by a test in advance. As a result of the above, the composite active material according to the present disclosure is obtained.

### 3. Producing Electrode

An electrode may be produced from the prepared composite active material 10. Specifically, for example, an electrode is produced by forming a slurry containing the composite active material 10, performing coating of this slurry on the surface of a substrate, and drying the resultant.

### 3.1. Slurry

For example, the slurry is formed by mixing the composite active material 10, an electronically conducting material, an ion conductive material, a binder, and a solvent. At this time, the mixture may be dispersed using an ultrasonic homogenizer or the like. The solid concentration of the slurry may be 50% by mass to 70% by mass.

The electronically conducting material can form electron conduction paths in the electrode. The electronically conducting material is incorporated in any amount. The amount of incorporating the electronically conducting material may be, for example, 0.1 part by mass to 10 parts by mass on the basis of 100 parts by mass of the active material. The electronically conducting material may contain any component. The electronically conducting material may contain, for example, at least one selected from the group consisting of carbon black (CB), vapor grown carbon fiber (VGCF), a carbon nanotube (CNT), and a graphene flake (GF). CB may contain, for example, at least one selected from the group consisting of acetylene black (AB), Ketjen black (registered trademark), and furnace black.

The ion conductive material can form electron conduction paths in the electrode. The ion conductive material may be in the form of particle. The ion conductive material may have a D50 of, for example, 0.01 μm to 1 μm, 0.01 μm to 0.95 μm, or 0.1 μm to 0.9 μm. The ion conductive material is incorporated in any amount. The amount of incorporating the ion conductive material on the basis of 100 parts by volume of the active material may be, for example, 1 part by volume to 200 parts by volume, 50 parts by volume to 150 parts by volume, or 50 parts by volume to 100 parts by volume. The ion conductive material may contain, for example, a sulfide SE, and a fluoride SE. The sulfide SE and the fluoride SE contained in the ion conductive material may be the same as or different from the sulfide SE and the fluoride SE contained in the electrode material, respectively.

The binder can bind any solid materials to each other. The amount of incorporating the binder may be, for example, 0.1 part by mass to 10 parts by mass on the basis of 100 parts by mass of the active material. The binder may contain any component. The binder may contain, for example, at least one selected from the group consisting of polyvinylidene fluoride (PVdF), a polyvinylidene fluoride-hexafluoropropylene copolymer (PVdF-HFP), styrene-butadiene rubber (SBR), butadiene rubber (BR), and polytetrafluoroethylene (PTFE).

### 3.2. Coating

In this producing method, any coater may be used. For example, a die coater or a roll coater may be used. Coating of the slurry may be performed on the surface of the substrate. The substrate may have conductivity. The substrate may function as a current collector. For example, the substrate may be in the form of sheet, and may be in the form of net. The substrate may have a thickness of, for example, 5 μm to 50 μm. The substrate may encompass, for example, metal foil, metal mesh, and a porous metal body. The substrate may contain, for example, at least one selected from the group consisting of Al, Cu, Ni, Cr, Ti and Fe. The substrate may contain, for example, an Al foil, an Al alloy foil, a Ni foil, a Cu foil, a Cu alloy foil, a Ti foil, and a stainless-steel foil. A carbon layer may coat the surface of a metal foil as used herein. A carbon layer as used herein may contain, for example, a conductive carbon material (such as AB).

A layer of the active material is formed by drying the slurry on the surface of the substrate. In this producing method, any dryer may be used. For example, a hot plate, a hot air dryer, or an infrared dryer may be used.

The electrode may be pressed after the slurry is dried. For example, cold pressing may be carried out, and hot pressing may be carried out. In this producing method, any press machine may be used. For example, a roll press machine may be used. When hot pressing is carried out, for example, the pressing temperature may be adjusted according to the kind of the binder etc. The pressing temperature may be, for example, 80° C. to 180° C. The active material layer after the pressing may have a thickness of, for example, 10 μm to 200 μm. The active material layer after the pressing may have a density of, for example, 2 g/cm³ to 4 g/cm³.

### 4. Producing All-Solid-State Battery

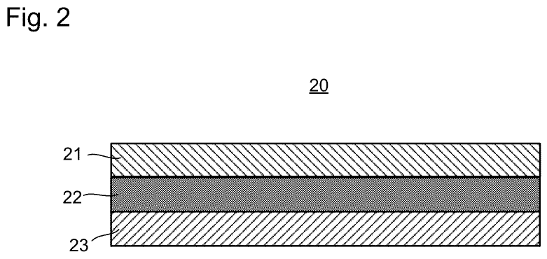

FIG. 2 is a schematic view showing the composition of the layers of one electricity generation component 20 included in an all-solid-state battery. Here, production of the all-solid-state battery will be described as one example whereas the present disclosure is directed to batteries using at least solid electrolytes as electrolytes as described above, and thus, the battery may be a battery using a solid electrolyte and a liquid electrolyte in combination as an electrolyte.

The electricity generation component 20 may be formed by stacking a positive electrode 21, a separator layer 22, and a negative electrode 23. At least one of the positive electrode 21 and the negative electrode 23 is the electrode obtained in the aforementioned manner. The separator layer 22 is disposed between the positive electrode 21 and the negative electrode 23. The separator layer 22 may contain, for example, an ion conductive material and a binder. The separator layer 22 may be formed, for example, by slurry coating on the surface of at least one of the positive electrode 21 and the negative electrode 23.

After formed, the electricity generation component 20 may be hot-pressed. It is expected that hot-pressing causes the electricity generation component 20 to be compact.

For example, lead tabs and external terminals may be connected to the electricity generation component 20. The electricity generation component 20 is accommodated in a housing (not shown). The housing may be hermetically sealed. Accommodating the electricity generation component 20 in the housing can lead to the completion of the all-solid-state battery.

The housing may have any form. The housing may be, for example, a pouch made of a metal foil laminated film. The housing may be, for example, a metal case. The housing may contain, for example, Al. The housing may accommodate one electricity generation component 20 alone, and may accommodate a plurality of the electricity generation components 20. A plurality of the electricity generation components 20 may form a series circuit, and may form a parallel circuit.

### EXAMPLES

### 5. Examples

In the examples, a composite active material was prepared and subjected to moisture adsorption to examine the relationship between the water content and the resistance increase. Specifically, see the following. The present disclosure is not limited to the examples.

### 5.1. Preparing Composite Active Material

As an active material, Li(NiCoAl)O₂ was used. “Li(NiCoAl)O₂” is hereinafter abbreviated as “NCA”.

A fluoride solid electrolyte was synthesized by mixing LiF, TiF₄, and AlF₃ by planetary ball milling. The fluoride solid electrolyte had the composition of Li_{2.7}Ti_{0.3}Al_{0.7}F₆. “Li_{2.7}Ti_{0.3}Al_{0.7}F₆” is hereinafter abbreviated as “LTAF”.

“Nobilta NOB-MINI (manufactured by Hosokawa Micron Corporation)” was used as a particle composing machine. In the particle composing machine, 48.7 parts by mass of NCA, and 1.3 parts by mass of LTAF were subjected to composing processing, thereby forming an active material coated with a first coat layer. The following were the operating conditions of the machine: 12 W per 1 g of the material in electric power; 6000 rpm in rotational speed; and 30 minutes in processing time.

Next, for a second coat layer, Li₂S—P₂S₅ (glass ceramic, hereinafter “LPS”) as a sulfide solid electrolyte, and THN as a solvent were prepared. Then, the following were carried out in an environment in which the dew point temperature was controlled to be at −70° C. or lower.

The subsequent operations were performed in the environment in which the dew point temperature was controlled to be at −70° C. or lower. An ultrasonic homogenizer was prepared as dispersion equipment. By the use of this, 98.4 parts by mass of the sulfide solid electrolyte was dispersed throughout 229.6 parts by mass of the solvent to prepare a fluid dispersion.

A planetary mixer was prepared as a kneader. Here, 1000 parts by mass of the active material coated with the first coat layer was fed to the kneader. The fluid dispersion obtained in the aforementioned way was further fed to the kneader.

“Stiff kneading” and “solvent addition” were repeated in turn in the order from item (1) to item (7) below whereby a composite active material that was the active material which was coated with the first coat layer and the second coat layer was obtained.
(1) Stiff kneading: 70 rpm in rotational speed; and 10 minutes in time
(2) Solvent addition: THN (34 parts by mass)
(3) Stiff kneading: 100 rpm in rotational speed; and 10 minutes in time
(4) Solvent addition: THN (37 parts by mass)
(5) Stiff kneading: 100 rpm in rotational speed; and 10 minutes in time
(6) Solvent addition: THN (23 parts by mass)
(7) Stiff kneading: 100 rpm in rotational speed; and 4 hours in time

Next, for tests, the obtained composite active material was subjected to moisture adsorption to prepare a plurality of composite active materials having different water contents at 200° C. (the definition of the water content is as described above). Specific water contents thereof are shown in table 1.

The adjustment of the water content was carried out by: putting the composite active material in a glove box where the dew point was controlled to be at −5° C. to expose the composite active material to the environment in the glove box, so that the composite active material adsorbed moisture. The water contents were adjusted depending on exposure times. Table 1 also shows specific exposure times.

Test examples 1 to 7 were as described above. In test example 8, no second coat layer was provided, and the active material was coated with the first coat layer only.

### 5.2. Preparing All-Solid-State Battery

All-solid-state batteries were prepared for testing the battery performance derived from each of the composite active materials. Each of the all-solid-state batteries is specifically as follows.

A slurry was prepared by dispersing the composite active material, an ion conductive material (LPS), and an electronically conducting material (AB and VGCF) throughout a solvent (THN) by the use of an ultrasonic homogenizer. A positive electrode was produced by performing coating of the slurry on the surface of a substrate, and drying the resultant.

Further, an all solid-state battery that included the positive electrode, used Li₄Ti₅O₁₂ as a negative electrode active material, and was encapsulated in a housing made of an Al laminated film was produced.

### 5.3. Battery Evaluation

The SOC (state of charge) of each of the all-solid-state batteries was set in 80%, and preserved in a 60° C. atmosphere for 2 weeks. Then, the SOC (state of charge) of each of the all-solid-state batteries was adjusted to 60%, and the all-solid-state batteries were discharged at an hour rate of 32 C for 10 seconds. The discharge resistance (DC resistance) was calculated from the voltage drop rate during the discharge, and the current. The discharge resistance was calculated at the time point when 2 seconds had passed.

Further, the all-solid-state batteries were charged at an hour rate of 60 C for 5 seconds. The initial charge resistance (DC resistance) was calculated from the voltage rise rate during the charge, and the current. The charge resistance was calculated at the time point when 5 seconds had passed.

The discharge resistance and the charge resistance in each of the examples were expressed by proportions (percentages) on the basis of the discharge resistance and the charge resistance in example 1 (exposure time: 0 minute). Specifically, the increase rate obtainable by [(Rᵢ−R₁)/R₁]×100% was calculated when the value of the resistance in test example i was defined as Rᵢ. The results are shown in table 1.

TABLE 1

| | Ex- | Water | | | |
|---|---|---|---|---|---|
| Test | posure | content at | | | |
| exam- | time | 200° C. | Resistance increase rate (%) | | |
| ples | (min.) | (ppm) | Charge | Discharge | References |
| 1 | 0 | 10 | 0.0 | 0.0 | basis |
| 2 | 2 | 60 | −2.3 | −2.8 | example |
| 3 | 3 | 85 | −3.8 | −5.5 | example |
| 4 | 7 | 195 | −1.5 | −1.5 | example |
| 5 | 9 | 299 | −0.4 | −1.6 | example |
| 6 | 18 | 802 | −0.8 | −1.6 | example |
| 7 | 20 | 920 | 7.2 | 7.3 | comparative |
| | | | | | example |
| 8 | 9 | 331 | 9.4 | 8.6 | comparative |
| | | | | | example |
| | | | | | (no second |
| | | | | | coat layer) |

It was found that when any of the composite active materials of the test examples according to the example was used, a higher water content than the basis could lead to a lower resistance increase rate as long as the water content at 200° C. that led to 0% in resistance increase rate in the discharge was at most 823 ppm.

In test example 8, where no second coat layer was provided, the water content was equal to that in test example 5, but the resistance increase rate became higher.
10 Composite active material
11 Active material
12 First coat layer
13 Second coat layer
20 Electricity generation component
21 Positive electrode
22 Separator layer
23 Negative electrode

What is claimed is:

1. A composite active material that is used for solid-state batteries, the composite active material comprising:
an active material;
a first coat layer that contains a fluoride-containing first solid electrolyte, the first coat layer coating at least part of a surface of the active material; and
a second coat layer that contains a sulfide-containing second solid electrolyte, and a solvent, the second coat layer coating at least part of the first coat layer, wherein a water content of the composite active material at 200° C. measures at most 823 ppm on a Karl Fischer titrator.

2. The composite active material according to claim 1, wherein
the water content of the composite active material at 200° C. measures at least 10 ppm on a Karl Fischer titrator.

3. The composite active material according to claim 1, wherein
in the water content of the composite active material, a water content of the second coat layer is higher than a water content of the first coat layer.
